(19) United States
(12) Patent Application Publication
(10) Pub. No.: US 2025/0175063 A1
(43) Pub. Date: May 29, 2025

(54) METHOD FOR MANUFACTURING ROTOR AND APPARATUS FOR MANUFACTURING ROTOR

(71) Applicant: TOYOTA BOSHOKU KABUSHIKI KAISHA, Aichi-ken (JP)

(72) Inventors: Keita NAMBA, Nagoya-shi (JP); Yasunori SAKURAI, Hashima-shi (JP)

(73) Assignee: TOYOTA BOSHOKU KABUSHIKI KAISHA, Aichi-ken (JP)

(21) Appl. No.: 18/950,584

(22) Filed: Nov. 18, 2024

(30) Foreign Application Priority Data
Nov. 24, 2023 (JP) 2023-199136

(51) Int. Cl. H02K 15/03; H02K 1/276; H02K 1/28; H02K 15/12

(52) U.S. Cl. CPC H02K 15/03; H02K 1/276; H02K 1/28; H02K 15/12

(57) ABSTRACT

A method for manufacturing a rotor includes a pre-processing step of forming a workpiece, a first conveying step of conveying the workpiece to a molding device, a molding step, a second conveying step of conveying the workpiece to a post-processing device, and a post-processing step of performing a post-processing process on the workpiece. During normal execution of the steps, the steps are performed so that a predetermined number of workpieces are retained in a retention space of a first conveying device, and a vacant space is set in a second conveying device. When at least one of the pre-processing step and the post-processing step is stopped, the first conveying step conveys the workpiece to the molding device, the molding step performs molding of a resin material on the conveyed workpiece by the molding device, and the second conveying step conveys the workpiece after the molding step to the vacant space.

### CROSS-REFERENCE TO RELATED APPLICATIONS

This application is based upon and claims the benefit of priority from prior Japanese Patent Application No. 2023-199136, filed on Nov. 24, 2023, the entire contents of which are incorporated herein by reference.

### BACKGROUND

### 1. Field

The following description relates to a method for manufacturing a rotor and an apparatus for manufacturing a rotor.

### 2. Description of Related Art

A rotating electric machine includes a cylindrical stator and a rotor that rotates inside the stator. A rotor for a magnet-embedded rotating electric machine typically includes a rotor core having magnet housing holes, magnets accommodated in the magnet housing holes, and a resin material that fills the magnet housing holes and fixes the magnets to the rotor core.

A series of steps is repeated to manufacture such rotors. First, a pre-processing step accommodates magnets in the magnet housing holes of the rotor core. Then, a molding step molds the resin material in the magnet housing holes by a molding machine. Subsequently, a post-processing step performs a post-processing process, such as removing a jig. The rotors are manufactured through these steps.

### SUMMARY

When manufacturing the rotors, a pre-processing device used in the pre-processing step or a post-processing device used in the post-processing step may be stopped due to an occurrence of an abnormality or the like. In this case, the molding machine may no longer receive a workpiece prior to the molding of the resin material or eject a workpiece after the molding of the resin material. Accordingly, even if the molding machine is in a normal operation state, the molding machine may not operate. This may lower the operation rate of the molding machine, thereby reducing the efficiency of producing of the rotors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method in accordance with one general aspect of the present disclosure is for manufacturing a rotor. The rotor includes a rotor core having a magnet housing hole, a magnet accommodated in the magnet housing hole, and a resin material filling the magnet housing hole and fixing the magnet to the rotor core. The method includes a pre-processing step of forming a workpiece in which the magnet is accommodated in the magnet housing hole; a first conveying step of conveying the workpiece to a molding device, the molding device including a molding machine, by a first conveying device after the pre-processing step; a molding step of molding the resin material in the magnet housing hole by the molding device after the first conveying step; a second conveying step of conveying the workpiece from the molding device to a post-processing device by a second conveying device after the molding step; and a post-processing step of performing a post-processing process on the workpiece by the post-processing device after the second conveying step. During normal execution of the steps of manufacturing the rotor, the steps are performed so that a predetermined number of the workpiece is retained in a retention space of the first conveying device, and a vacant space for retaining the predetermined number or more of the workpiece is set in the second conveying device. When at least one of the pre-processing step and the post-processing step is stopped, the first conveying step conveys the workpiece retained in the retention space to the molding device, the molding step performs molding of the resin material on the conveyed workpiece by the molding device, and the second conveying step conveys the workpiece after the molding step to the vacant space.

An apparatus in accordance with another general aspect of the present disclosure is for manufacturing a rotor. The rotor includes a rotor core having a magnet housing hole, a magnet accommodated in the magnet housing hole, and a resin material filling the magnet housing hole and fixing the magnet to the rotor core. The apparatus includes a pre-processing device configured to form a workpiece in which the magnet is accommodated in the magnet housing hole, a molding device including a molding machine and configured to mold the resin material in the magnet housing hole in the workpiece with the molding machine, a post-processing device configured to perform a post-processing process on the workpiece in which the resin material is molded, a first conveying device configured to convey the workpiece from the pre-processing device to the molding device, a second conveying device configured to convey the workpiece from the molding device to the post-processing device, and circuitry that controls actuation of the devices in the manufacturing apparatus. During normal operation of the devices, the circuitry is configured to control actuation of the devices so that a predetermined number of the workpiece is retained in the first conveying device, and a vacant space for retaining the predetermined number or more of the workpiece is set in the second conveying device. When at least one of the pre-processing device and the post-processing device is stopped, the circuitry is configured to control actuation of the molding device, the first conveying device, and the second conveying device so that the workpiece retained in the first conveying device is conveyed to the molding device, the molding device performs molding of the resin material on the conveyed workpiece, and the workpiece after the molding of the resin material is ejected to the vacant space of the second conveying device.

Other features and aspects will be apparent from the following detailed description, the drawings, and the claims.

### BRIEF DESCRIPTION OF THE DRAWINGS

FIG. 1 is a plan view of a rotor manufactured by a method for manufacturing a rotor in accordance with an embodiment.

FIG. 2 is a cross-sectional side view of the rotor.

FIG. 3 is a schematic diagram showing the configuration of an apparatus for manufacturing the rotor.

FIG. 4 is a cross-sectional side view showing a workpiece formed by a pre-processing step.

FIG. 5 is a schematic diagram showing an actuation state of the manufacturing apparatus during normal operation of each device.

FIG. 6 is a flowchart illustrating an execution procedure of an actuation control process.

FIGS. 7A, 7B, 7C, and 7D are schematic diagrams showing an actuation state of the manufacturing apparatus when operations of a pre-processing device and a post-processing device are stopped in a state in which the workpiece is present inside the molding device.

FIGS. 8A, 8B, and 8C are schematic diagrams showing an actuation state of the manufacturing apparatus when operations of the pre-processing device and the post-processing device are stopped in a state in which the workpiece is not present inside the molding device.

FIGS. 9A, 9B, 9C, and 9D are schematic diagrams showing an actuation state of a manufacturing apparatus in accordance with another embodiment when operations of a pre-processing device and a post-processing device are stopped.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

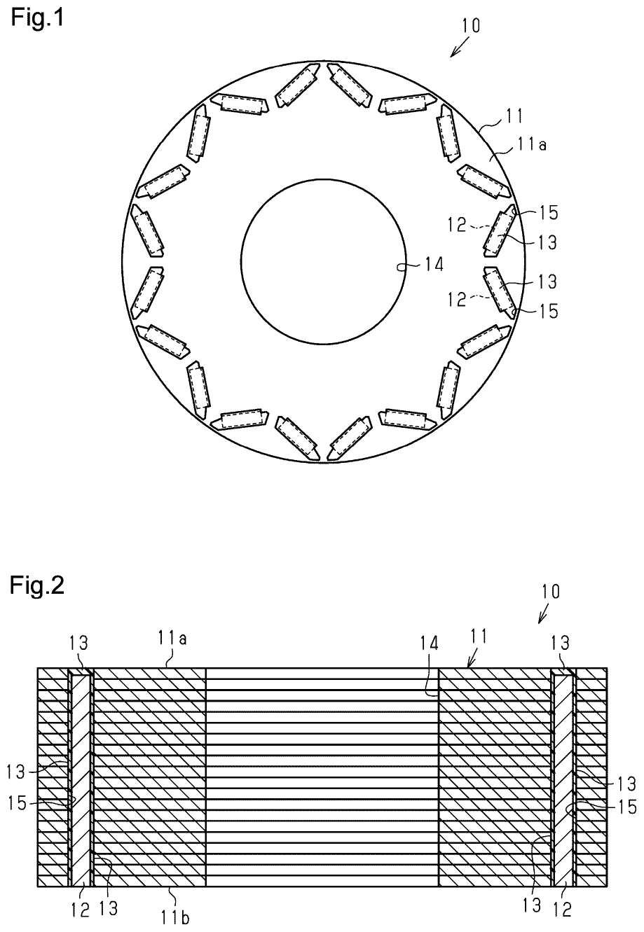

An embodiment of a method for manufacturing a rotor and an apparatus for manufacturing a rotor will now be described with reference to FIGS. 1 to 8C.

### Rotor 10

First, a rotor to which the manufacturing method and the manufacturing apparatus of the present embodiment are applied is described.

As shown in FIGS. 1 and 2, a rotor 10 includes a rotor core 11, magnets 12, and a resin material 13. For example, the rotor 10 is for use with a magnet-embedded motor.

### Rotor Core 11

The rotor core 11 is substantially cylindrical.

As shown in FIG. 2, the rotor core 11 is formed, for example, by stacking iron core pieces that are punched out from an electromagnetic steel sheet. The rotor core 11 includes a first end face 11a and a second end face 11b that are located on opposite sides in an axial direction of the rotor core 11 (hereinafter, simply referred to as the axial direction). The rotor core 11 includes a center hole 14 and magnet housing holes 15. The center hole 14 receives a shaft (not shown). The magnet housing holes 15 accommodate magnets 12. The magnet housing holes 15 are formed at intervals in a circumferential direction of the rotor core 11.

The center hole 14 and the magnet housing holes 15 extend through the rotor core 11 in the axial direction. That is, the center hole 14 and the magnet housing holes 15 are open in the first end face 11a and the second end face 11b. As shown in FIG. 1, each magnet housing hole 15 has a substantially quadrangular cross-sectional shape orthogonal to the axial direction. The cross-sectional shape includes long sides and short sides. The cross-sectional shape of the magnet housing hole 15 is constant over the entire length in the axial direction.

### Magnet 12

Each magnet 12 is accommodated in a corresponding one of the magnet housing holes 15. The magnet 12 is fixed to the rotor core 11 by the resin material 13 that fills the magnet housing hole 15.

As shown in FIG. 2, each magnet 12 has an elongated shape in the axial direction. The magnet 12 has a substantially rectangular cross-sectional shape orthogonal to the axial direction. The rectangular cross-sectional shape has long sides and short sides.

### Resin Material 13

The resin material 13 fills, for example, a gap between inner walls of the magnet housing hole 15 and outer surfaces of the magnet 12 along an entire circumference of the magnet 12. The resin material 13 is formed of a thermoplastic resin material.

### Manufacturing Apparatus

A manufacturing apparatus 20 used for manufacturing the rotor 10 will now be described.

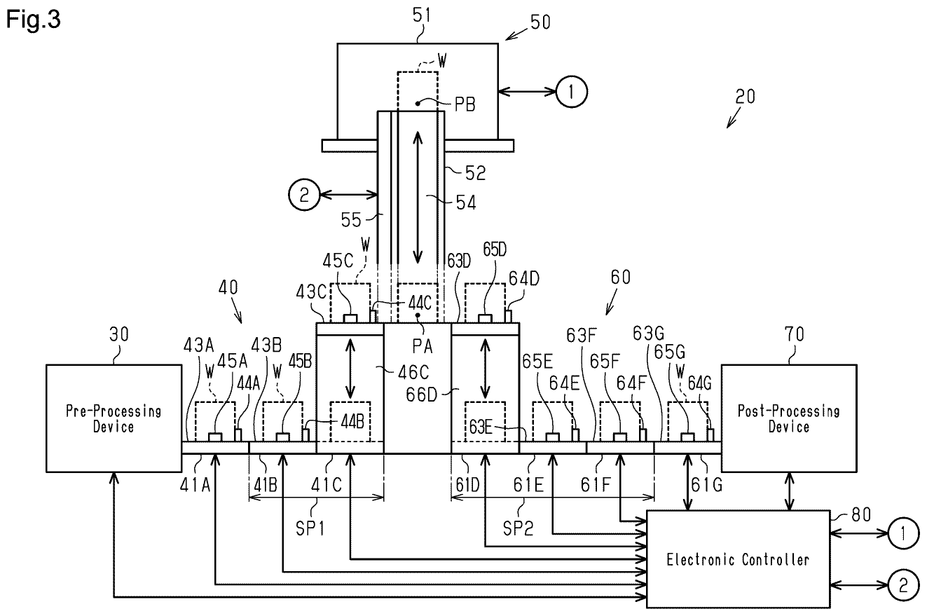

As shown in FIG. 3, the manufacturing apparatus 20 includes a pre-processing device 30, a first conveying device 40, a molding device 50, a second conveying device 60, and a post-processing device 70. The devices 30, 40, 50, 60, and 70 are arranged in the order of the pre-processing device 30, the first conveying device 40, the molding device 50, the second conveying device 60, and the post-processing device 70 from an upstream side in a moving direction of the rotor 10 (hereinafter, simply referred to as the upstream side). Specifically, the moving direction of the rotor 10 corresponds to the moving direction of the workpiece W.

### Pre-Processing Device 30

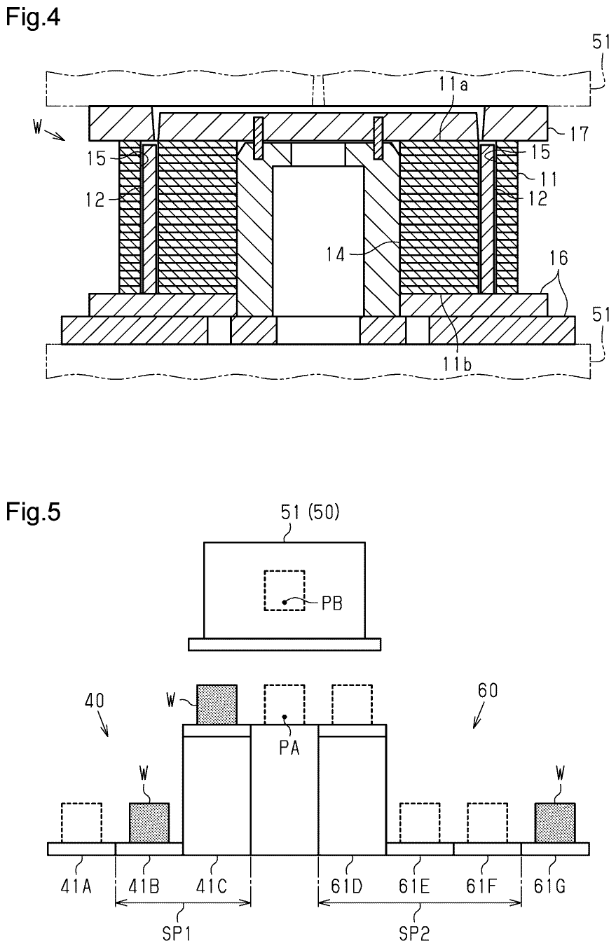

The pre-processing device 30 forms the workpiece W in which the magnets 12 are accommodated in magnet housing holes 15 of the rotor core 11 (refer to FIG. 1). More specifically, as shown in FIG. 4, the rotor core 11 is set on a pallet 16. In this state, the magnets 12 are accommodated in the magnet housing holes 15 of the rotor core 11. Then, a gate plate 17 is mounted on the rotor core 11 and the pallet 16.

### First Conveying Device 40

As shown in FIG. 3, the first conveying device 40 conveys the workpiece W from the pre-processing device 30 to the molding device 50.

The first conveying device 40 includes three carriers 41A, 41B, and 41C. The carriers 41A to 41C are arranged in the order of the carrier 41A, the carrier 41B, and the carrier 41C from the upstream side (left side in FIG. 3).

The carrier 41A includes, for example, an electric roller conveyor 43A and a stopper 44A. The electric roller conveyor 43A conveys the workpiece W toward a downstream side in the moving direction (hereafter, simply referred to as the downstream side). The stopper 44A restricts movement of the workpiece W on the electric roller conveyor 43A. The carrier 41A includes a workpiece sensor 45A that detects whether the workpiece W is present on the electric roller conveyor 43A.

The carrier 41B includes, for example, an electric roller conveyor 43B and a stopper 44B. The electric roller conveyor conveys the workpiece W toward the downstream side. The stopper 44B restricts movement of the workpiece W on the electric roller conveyor 43B. The carrier 41B includes a workpiece sensor 45B that detects whether the workpiece W is present on the electric roller conveyor 43B.

The carrier 41C includes, for example, an electric roller conveyor 43C, a stopper 44C, and a lifter 46C. The electric roller conveyor 43C conveys the workpiece W toward the downstream side. The stopper 44C restricts movement of the workpiece W on the electric roller conveyor 43C. The lifter 46C moves the electric roller conveyor 43C in a vertical direction. The lifter 46C includes, for example, a linear motor. Actuation of the lifter 46C is controlled to control the vertical position of the electric roller conveyor 43C. When the electric roller conveyor 43C is moved to a lower position, the electric roller conveyor 43C receives the workpiece W from the electric roller conveyor 43B of the carrier 41B. When the electric roller conveyor 43C is moved to an upper position, the electric roller conveyor 43C sends the workpiece W to the molding device 50. The carrier 41C includes a workpiece sensor 45C that detects whether the workpiece W is present on the electric roller conveyor 43C.

As shown in FIG. 5, in the present embodiment, during normal operation of the devices 30, 40, 50, 60, and 70, actuation of the first conveying device 40 is controlled so that a predetermined number (two in the present embodiment) of workpieces W are retained in a retention space SP1 of the first conveying device 40.

In the present embodiment, the carriers 41B and 41C of the first conveying device 40 correspond to the retention space SP1 of the first conveying device 40. In the present embodiment, the workpiece W retained in the retention space SP1 is conveyed to the molding device 50 under a condition in which the first conveying device 40 retains three workpieces W. In other words, the carriers 41A to 41C each retain one workpiece W. More specifically, the workpiece W on the carrier 41C is conveyed to the molding device 50 under a condition in which the carriers 41B and 41C each retain one workpiece W and another workpiece W has arrived at the carrier 41A. Further, in accordance with the above transportation, the workpiece W on the carrier 41B is conveyed to the carrier 41C, and the workpiece W on the carrier 41A is conveyed to the carrier 41B.

### Molding Device 50

The molding device 50 includes a molding machine 51 and a loading machine 52.

### Molding Machine 51

The molding machine 51 includes an injection molding machine. The molding machine 51 molds the resin material 13 in the magnet housing holes 15 of the rotor core 11.

When the molding machine 51 performs the molding, a thermoplastic resin material, which has been heated and melted, is prepared inside the molding machine 51. Thus, if the operation of the molding machine 51 is stopped for a prolonged period of time, the resin material inside the molding machine 51 may deteriorate and become unusable. In such a case, the resin material inside the molding machine 51 is removed (purging process) before the molding machine 51 resumes the molding.

### Loading Machine 52

The loading machine 52 is configured to load the workpiece W that prior to the molding of the resin material 13 into the molding machine 51, and eject the workpiece W after the molding of the resin material 13 from the molding machine 51. The loading machine 52 includes, for example, an arm (not shown) that engages the workpiece W, a guide 54 that guides the workpiece W, and an actuation controller 55 that controls actuation of the arm. When moving the workpiece W, the actuation controller 55 executes an actuation control so that the arm catches the workpiece W, specifically, the pallet 16. In such a state, the arm is moved so that the workpiece W is guided by the guide 54 together with the pallet 16.

The molding device 50 may be at a standby position PA set outside the molding machine 51 or at a processing position PB set inside the molding machine 51. The standby position PA is located adjacent to the carrier 41C. The carrier 41C sends the workpiece W to the standby position PA.

When the molding machine 51 performs molding, the loading machine 52 loads the workpiece W into the molding machine 51 by moving the workpiece W at the standby position PA to the processing position PB. Further, when the molding machine 51 completes the molding, the loading machine 52 ejects the workpiece W from the molding machine 51 by moving the workpiece W at the processing position PB to the standby position PA. In the present embodiment, the loading machine 52 is part of a conveying device that conveys the workpiece W.

### Second Conveying Device 60

As shown in FIG. 3, the second conveying device 60 conveys the workpiece W, after the molding by the molding machine 51, from the standby position PA of the molding device 50 to a vacant space SP2 of the second conveying device 60 or to the post-processing device 70.

The second conveying device 60 includes four carriers 61D, 61E, 61F, and 61G. The carriers 61D to 61G are arranged in the order of the carrier 61D, the carrier 61E, the carrier 61F, and the carrier 61G from the upstream side (left side in FIG. 3).

The carrier 61D includes, for example, an electric roller conveyor 63D, a stopper 64D, and a lifter 66D. The electric roller conveyor 63D conveys the workpiece W toward the downstream side. The stopper 64D restricts movement of the workpiece W on the electric roller conveyor 63D. The lifter 66D moves the electric roller conveyor 63D in the vertical direction. The lifter 66D includes, for example, a linear motor. Actuation of the lifter 66D is controlled to move the electric roller conveyor 63D in the vertical direction. When the electric roller conveyor 63D is moved to an upper position, the electric roller conveyor 63D receives the workpiece W from the standby position PA of the molding device 50. When the electric roller conveyor 63D is moved to a lower position, the electric roller conveyor 63D sends the workpiece W to the carrier 61E. The carrier 61D includes a workpiece sensor 65D that detects whether the workpiece W is present on the electric roller conveyor 63D.

The carriers 61E, 61F, and 61G respectively include, for example, electric roller conveyors 63E, 63F, and 63G that convey the workpiece W toward the downstream side, and stoppers 64E, 64F, and 64G that restrict movement of the workpiece W on the electric roller conveyors 63E, 63F, and 63G. The carriers 61E, 61F, and 61G respectively include workpiece sensors 65E, 65F, and 65G that detect whether the workpiece W is present on the electric roller conveyors 63E, 63F, and 63G.

In the present embodiment, during normal operation of the devices 30, 40, 50, 60, and 70, actuation of the second conveying device 60 is controlled so that the vacant space SP2 for retaining a specified number (three in the present embodiment) of the workpieces W is set in the second conveying device 60. The specified number is obtained by adding one to the predetermined number. As specifically shown in FIG. 5, during normal operation of the devices 30, 40, 50, 60, and 70, the workpiece W ejected from the molding device 50 is conveyed to the carrier 61G without being retained on the carriers 61D, 61E, or 61F. Thus, the carriers 61D, 61E, and 61F provide vacant spaces that do not include the workpiece W.

### Post-Processing Device 70

As shown in FIG. 3, the post-processing device 70 performs a post-processing process on the workpiece W, in which the resin material 13 is molded. The post-processing process removes the pallet 16 and the gate plate 17 from the workpiece W. When the post-processing device 70 performs the post-processing process, the carrier 61G of the second conveying device 60 sends the workpiece W to the post-processing device 70.

### Electronic Controller 80

The manufacturing apparatus 20 of the present embodiment includes an electronic controller 80. The electronic controller 80 includes, for example, a microcomputer. The electronic controller 80 may be circuitry including: 1) one or more processors that operate according to a computer program (software); 2) one or more dedicated hardware circuits (application specific integrated circuits, ASIC) that execute at least part of various processes; or 3) a combination thereof. The processor includes a central processing unit (CPU) and a memory, such as a random-access memory (RAM) or a read-only memory (ROM). The memory stores program codes or commands configured to cause the CPU execute processes. The memory, which is a computer readable medium, may be any available medium accessible by a versatile or dedicated computer. The electronic controller 80 is connected to the pre-processing device 30, the first conveying device 40, the molding device 50, the second conveying device 60, and the post-processing device 70. The electronic controller 80 receives various signals indicating the actuation states of the devices 30, 40, 50, 60, and 70, and detection signals from the workpiece sensors 45A to 45C and 65D to 65G. The electronic controller 80 performs various calculations based on the received signals, and controls actuation of the devices 30, 40, 50, 60, and 70 in accordance with the calculation results.

### Method for Manufacturing Rotor 10

A manufacturing procedure of the rotor 10 will now be described.

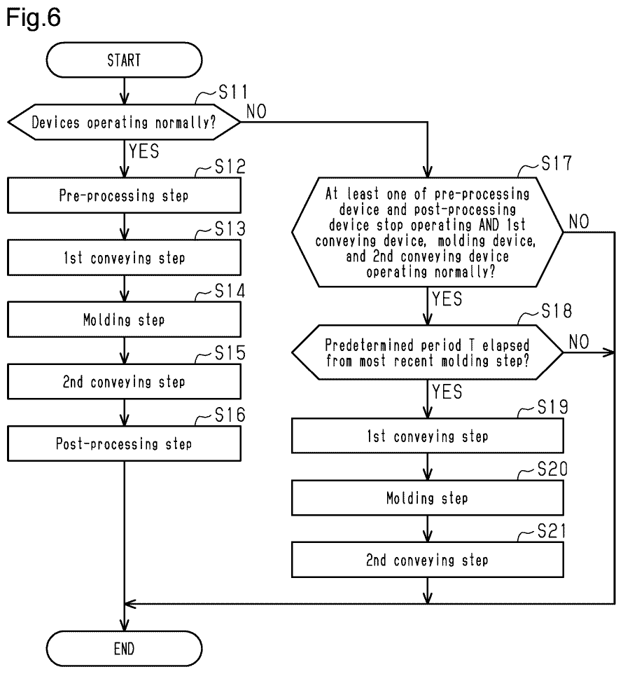

FIG. 6 illustrates an execution procedure related to actuation controls (actuation control process) on the devices 30, 40, 50, 60, and 70. The series of steps in the flowchart shown in FIG. 6 conceptually illustrates the execution procedure of the actuation control process. The actual process is executed by the electronic controller 80 in predetermined cycles.

### During Normal Operation of the Devices 30, 40, 50, 60, and 70

### Pre-Processing Step

As shown in FIG. 6, during normal operation of the devices 30, 40, 50, 60, and 70 (step S11: YES), the pre-processing step is performed (step S12).

The pre-processing step controls actuation of the pre-processing device 30 to form the workpiece W, in which the magnets 12 are accommodated in the magnet housing holes 15 of the rotor core 11 (refer to FIG. 4). The pre-processing step attaches the pallet 16 and the gate plate 17 to the rotor core 11.

### First Conveying Step

After the pre-processing step, the first conveying step is performed (step S13).

The first conveying step controls actuation of the first conveying device 40 to convey the workpiece W from the carrier 41C of the first conveying device 40 to the standby position PA of the molding device 50. The first conveying step controls actuation of the first conveying device 40 so that two workpieces W are retained in the retention space SP1 of the first conveying device 40.

### Molding Step

After the first conveying step, the molding step is performed (step S14).

The molding step controls actuation of the molding device 50 to mold the resin material 13 in the magnet housing holes 15 of the rotor core 11.

More specifically, first, the molding step controls actuation of the loading machine 52 to move the workpiece W from the standby position PA outside the molding machine 51 to the processing position PB inside the molding machine 51. Then, actuation of the molding machine 51 is controlled to mold the resin material 13 in the magnet housing holes 15 of the rotor core 11. Subsequently, actuation of the loading machine 52 is controlled to return the workpiece W from the processing position PB to the standby position PA. The molding device 50 of the present embodiment sends out the workpiece W after the molding and having been returned to the standby position PA, to the second conveying device 60 without retaining the workpiece W at the standby position PA.

### Second Conveying Step

After the molding step, the second conveying step is performed (step S15).

The second conveying step controls actuation of the second conveying device 60 to convey the workpiece W from the standby position PA of the molding device 50 to the post-processing device 70. The second conveying step controls actuation of the second conveying device 60 so that the vacant space SP2 for retaining three workpieces W is set in the second conveying device 60.

### Post-Processing Step

After the second conveying step, the post-processing step is performed (step S16).

The post-processing step controls actuation of the post-processing device 70 to perform the post-processing process on the workpiece W.

As shown in FIG. 5, during normal operation of the devices 30, 40, 50, 60, and 70, that is, during normal execution of the above steps, two workpieces W are retained in the retention space SP1, and the vacant space SP2 for retaining three workpieces W is set in the second conveying device 60. In the present embodiment, during normal execution of the above steps, the steps are repeated such that the molding machine 51 continues to operate in an intermittent manner.

### Operation of at Least One of the Pre-Processing Device 30 and the Post-Processing Device 70 Stopped

When the operation of at least one of the pre-processing device 30 and the post-processing device 70 is stopped, and the first conveying device 40, the molding device 50, and the second conveying device 60 are operating normally (S11: NO and S17: YES), the following processes (S18 to S21) are performed. In the present embodiment, “when the operation of at least one of the pre-processing device 30 and the post-processing device 70 is stopped” in the process of S17 means “when the operation of at least one of the pre-processing device 30 and the post-processing device 70 is stopped due to an abnormality or the like”.

In the series of processes (S18 to S21), first, the electronic controller 80 determines whether a predetermined period T (for example, thirty minutes) has elapsed from the most recent execution of the molding step (S18). In the present embodiment, a duration time for which the molding machine 51 continues to be inactive is calculated in advance. Specifically, even if the resin material inside the molding machine 51 deteriorates as the molding machine 51 continues to be inactive over the duration time, the resin material will not become unusable. In the present embodiment, such a duration time is stored in advance in the electronic controller 80 as the predetermined period T.

When the predetermined period T has elapsed from the most recent execution of the molding step (S18: YES), the molding device 50 uses the workpiece W in the retention space SP1 and molds the resin material 13 (S19 to S21).

### First Conveying Step

In this case, first, the first conveying step is performed (S19).

The first conveying step controls actuation of the first conveying device 40 to convey the workpiece W in the retention space SP1 of the first conveying device 40 to the standby position PA of the molding device 50.

### Molding Step

After the first conveying step, the molding step is performed (S20).

The molding step controls actuation of the loading machine 52 to move the workpiece W at the standby position PA to the processing position PB. Then, actuation of the molding machine 51 is controlled to mold the resin material 13 in the magnet housing holes 15 of the rotor core 11. Subsequently, actuation of the loading machine 52 is controlled to return the workpiece W from the processing position PB to the standby position PA.

### Second Conveying Step

After the molding step, the second conveying step is performed (S21).

The second conveying step controls actuation of the second conveying device 60 to convey the workpiece W at the standby position PA of the molding device 50 to the vacant space SP2 of the second conveying device 60.

As described above, in the present embodiment, when at least one of the pre-processing step and the post-processing step is stopped due to an abnormality or the like, the molding device 50 uses the workpiece W in the retention space SP1 and molds the resin material 13 each time the predetermined period T elapses from the most recent execution of the molding step.

When the predetermined period T has not elapsed from the most recent execution of the molding step (S18: NO), the process is ended without executing S19 to S21. In this case, the manufacturing apparatus 20 remains in a standby state until the predetermined period T elapses. Then, when the predetermined period T elapses (S18: YES), the molding device 50 uses the workpiece W in the retention space SP1 and molds the resin material 13 (S19 to S21). When at least one of the three devices 40, 50, and 60 is not operating normally (S17: NO), in other words, when at least one of the first conveying step, the molding step, and the second conveying step is stopped, the process is ended without executing S18 to S21.

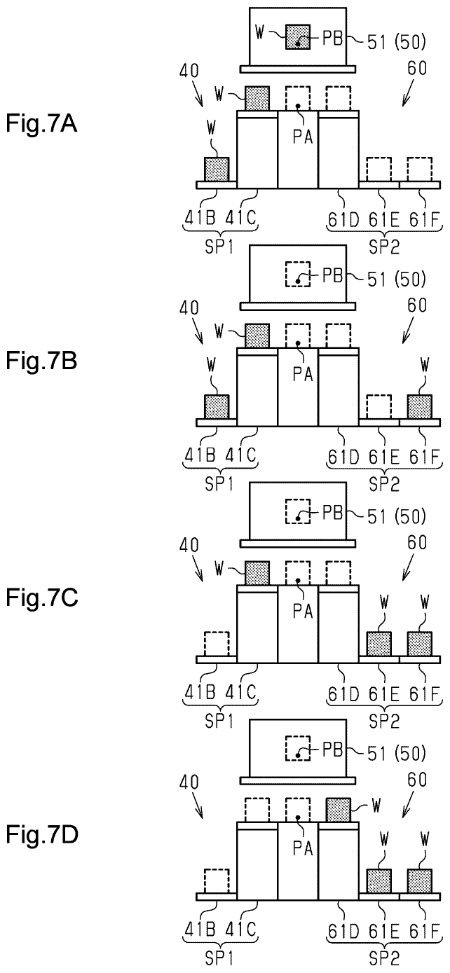

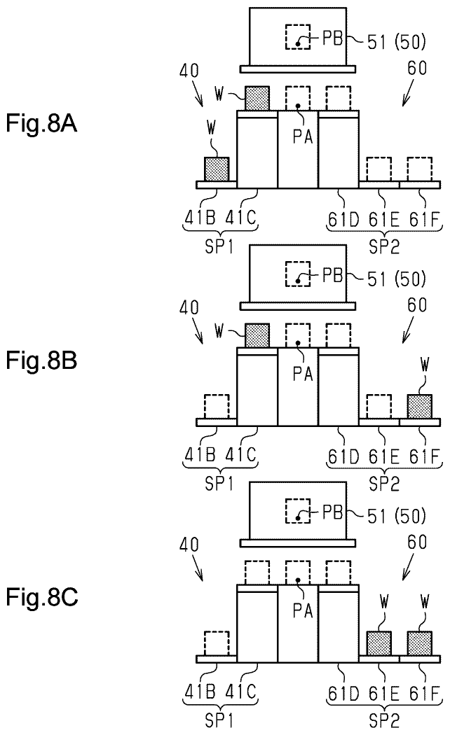

The operation of the present embodiment will now be described with reference to FIGS. 7A to 8C.

FIGS. 7A to 7D illustrate an example of the actuation state of the manufacturing apparatus 20 when the operations of the pre-processing device 30 and the post-processing device 70 are stopped due to an abnormality or the like in a state in which the workpiece W is present inside the molding device 50.

As shown in FIG. 7A, when the operations of the pre-processing device 30 and the post-processing device 70 are stopped, the workpiece W is present inside the molding device 50. In this case, the molding device 50 and the second conveying device 60 are operating normally. Thus, even when the pre-processing device 30 and the post-processing device 70 are inactive, the molding step and the second conveying step may be performed on the workpiece W inside the molding device 50.

As shown in FIG. 7B, after the molding device 50 completes the molding step, the workpiece W inside the molding device 50 is conveyed to the vacant space SP2 in the second conveying device 60. This decreases the quantity of the workpieces W that may be retained in the vacant space SP2 of the second conveying device 60 to two.

Then, when the predetermined period T elapses from the most recent execution of the molding step, the molding device 50 uses one of the two workpieces W retained in the retention space SP1 and performs the molding step. As illustrated in FIG. 7C, the quantity of the workpieces W retained in the retention space SP1 is decreased by one and becomes equal to one, and the quantity of the workpieces W retained in the vacant space SP2 is increased by one and becomes equal to two.

Thereafter, if the predetermined period T elapses again from the most recent execution of the molding step, the molding device 50 uses the one workpiece W remaining in the retention space SP1 and performs the molding step. As shown in FIG. 7D, the quantity of the workpieces W in the retention space SP1 becomes equal to zero, and the quantity of the workpieces W retained in the vacant space SP2 is increased by one and becomes equal to three. In other words, the number of vacant spots becomes equal to zero.

As described above, in the present embodiment, when the operation of the pre-processing device 30 and/or the post-processing device 70 is stopped in a state in which the workpiece W is present inside the molding device 50, the molding machine 51 uses the workpiece W retained in the retention space SP1 and continues to mold the resin material 13.

FIGS. 8A to 8C illustrate an example of the actuation state of the manufacturing apparatus 20 when the operations of the pre-processing device 30 and the post-processing device 70 are stopped due to an abnormality or the like in a state in which the workpiece W is not present inside the molding device 50.

As shown in FIG. 8A, when the operations of the pre-processing device 30 and the post-processing device 70 are stopped, the workpiece W is not present inside the molding device 50.

In this case, when the predetermined period T elapses from the most recent execution of the molding step, the molding device 50 uses one of the two workpieces W retained in the retention space SP1 and performs the molding step. As illustrated in FIG. 8B, the quantity of the workpieces W retained in the retention space SP1 is decreased by one and becomes equal to one, and one workpiece W is retained in the vacant space SP2.

Thereafter, if the predetermined period T elapses again from the most recent execution of the molding step, the molding device 50 uses the one workpiece W remaining in the retention space SP1 and performs the molding step. As shown in FIG. 8C, the quantity of the workpieces W in the retention space SP1 becomes equal to zero, and the quantity of the workpieces W retained in the vacant space SP2 is increased by one and becomes equal to two.

As described above, in the present embodiment, when the operation of the pre-processing device 30 and/or the post-processing device 70 is stopped in a state in which the workpiece W is not present inside the molding device 50, the molding machine 51 uses the workpiece W retained in the retention space SP1 and continues to mold the resin material 13.

### Advantages

The present embodiment has the following advantages.

(1) In the present embodiment, during normal execution of the pre-processing step, the first conveying step, the molding step, the second conveying step, and the post-processing step, these steps are repeated so that the molding machine 51 continues to operate in an intermittent manner. Further, even when the pre-processing step and/or the post-processing step is stopped due to an abnormality or the like, as long as the first conveying step, the molding step, and the second conveying step may be performed, the molding machine 51 molds the resin material 13 as described below. Specifically, the molding machine 51 uses the vacant space SP2 set in the second conveying device 60 and the workpiece W retained in the retention space SP1 of the first conveying device 40, and continues to mold the resin material 13. In this manner, the present embodiment limits reduction in the operation rate of the molding machine 51 even when the pre-processing step and/or the post-processing step is stopped. This maintains the efficiency of producing of the rotor 10.

When the pre-processing step and/or the post-processing step is stopped, the molding machine 51 performs the molding step when the predetermined period T elapses from the most recent execution of the molding step, in other words, before the resin material prepared in advance in the molding machine 51 becomes unusable. With the present embodiment, such a molding machine 51 uses the two workpieces W retained in the retention space SP1 and performs the molding step twice.

Therefore, even when the pre-processing step and/or the post-processing step is stopped due to an abnormality or the like, during a subsequent period (hereafter, specific period) in which the molding machine 51 performs the molding step twice, the resin material in the molding machine 51 will not deteriorate to a level at which the resin material becomes unusable. Specifically, the specific period includes a period from when the pre-processing step and/or the post-processing step is stopped to when the molding machine 51 completes the molding step twice, and a period from when the molding machine 51 completes the second molding step to when the predetermined period T elapses. The specific period may, at most, be a period obtained by multiplying the predetermined period T by three (T x 3).

Thus, if the operation of the pre-processing device 30 or the post-processing device 70 is stopped for a period that is shorter than the specific period, a purging process does not have to be performed before the manufacturing apparatus 20 resumes the production of the rotor 10, which uses the pre-processing device 30 and the post-processing device 70. In this case, a purging process will not lower the operation rate of the molding machine 51. This limits reduction in the operation rate of the manufacturing apparatus 20, which includes the molding machine 51, thereby maintaining the efficiency of producing of the rotor 10.

(2) The retention space SP1 is set as a space for retaining a predetermined number (two in the present embodiment) of the workpieces W, and the vacant space SP2 is set as a space for retaining a specified number (three in the present embodiment) of the workpieces W. The specified number is obtained by adding one to the predetermined number.

In the present embodiment, the workpiece W, after the molding step by the molding device 50, is ejected to the second conveying device 60 without being retained in the molding device 50. Accordingly, if the vacant space SP2 were to be set without considering the workpiece W inside the molding device 50, when the pre-processing step or the post-processing step is stopped, there would not be enough vacant space SP2 to receive the workpiece W ejected from the molding device 50 in the second conveying step. In this case, although the workpieces W are retained in the retention space SP1, the molding machine 51 would not be able to use the workpieces W to mold the resin material 13.

In this respect, the present embodiment sets the number of workpieces W that may be retained in the vacant space SP2 in accordance with the number of workpieces W that may be retained in the retention space SP1 during normal execution of the steps so as to maintain a sufficient amount of the vacant space SP2. Thus, even when the workpiece W after the molding step is ejected without being retained in the molding device 50, the molding machine 51 may use the vacant space SP2 of the second conveying device 60 and the workpiece W in the retention space SP1 and continues to mold the resin material 13.

(3) During normal execution of the steps, the first conveying step conveys the workpiece W retained in the retention space SP1 to the standby position PA of the molding device 50 under a condition in which the first conveying device 40 retains the specified number (three in the present embodiment) of workpieces W. The specified number is obtained by adding one to the predetermined number.

With this configuration, when conveying the workpiece W from the retention space SP1 to the standby position PA, a workpiece W retained outside the retention space SP1 (specifically, on the carrier 41A) is added to the retention space SP1. This ensures that two workpieces W remain in the retention space SP1 during normal operation of the devices 30, 40, 50, 60, and 70. Thus, even when the pre-processing step and/or the post-processing step is stopped, the molding machine 51 may use the two workpieces W retained in the retention space SP1 of the first conveying device 40 and perform the molding of the resin material 13 twice.

### Modified Examples

The above embodiment may be modified as follows. The above embodiment and the following modifications can be combined as long as the combined modifications remain technically consistent with each other.

The condition for conveying the workpiece W from the retention space SP1 to the standby position PA during normal operation of the devices 30, 40, 50, 60, and 70 may be changed as long as two workpieces W remain retained in the retention space SP1. For example, the condition may be “the workpiece W after the molding step is ejected from the standby position PA to the second conveying device 60”.

The lifter 46C of the carrier 41C may be omitted. In this case, the carriers 41A to 41C and the molding device 50 may be arranged so that the electric roller conveyors 43A to 43C are linearly aligned with the standby position PA of the molding device 50 in side view.

The lifter 66D of the carrier 61D may be omitted. In this case, the molding device 50 and the carriers 61D to 61G may be arranged so that the standby position PA of the molding device 50 is linearly aligned with the electric roller conveyor 63D to 63G in side view.

The conveying device for conveying the workpiece W does not have to include the electric roller conveyors 43A to 43C and 63D to 63G, and may include any type of conveyors such as an inclined roller conveyor. The conveying device may have any configuration as long as the workpiece W may be sent toward the downstream side at a predetermined point in time.

The predetermined number is not limited to two, and may be any natural number of one or three or more.

The manufacturing apparatus may be configured so that the workpiece W after the molding step by the molding device 50 is retained at the standby position PA of the molding device 50.

In such a manufacturing apparatus, the number of workpieces W retained in advance in the retention space SP1 in preparation for when the pre-processing step or the post-processing step stops is equal to the number of workpieces W that will be ejected from the molding device 50 to the vacant space SP2 when the pre-processing step or the post-processing step stops and the molding machine 51 performs molding.

Thus, the manufacturing apparatus may be set such that, during normal operation of the devices 30, 40, 50, 60, and 70, the number (predetermined number) of workpieces W retained in the retention space SP1 is equal to the number of workpieces W that may be retained in the vacant space SP2. With such a configuration, the number of workpieces W retained in the retention space SP1 and the number of workpieces W that may be retained in the vacant space SP2 are both set without excess or deficiency. This simplifies the configurations of the devices for manufacturing the rotor 10.

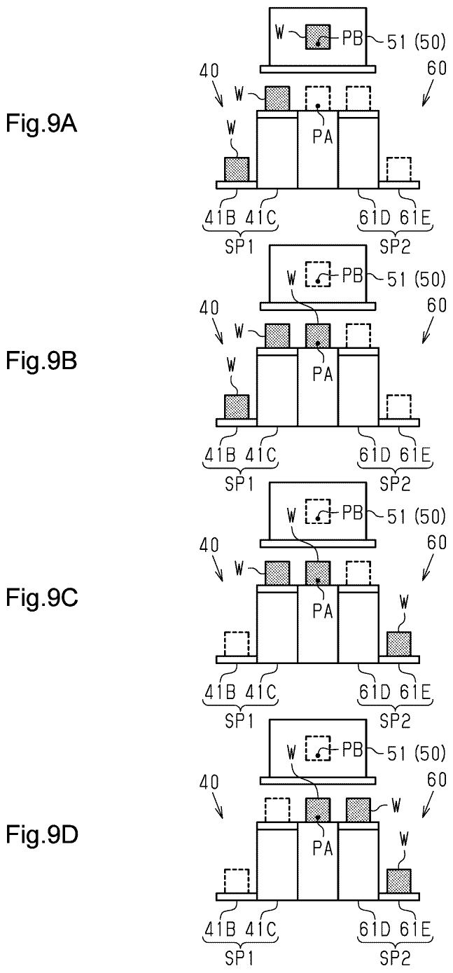

The operation of the above-described manufacturing apparatus will now be described with reference to FIGS. 9A to 9D. Same reference numerals are given to those components that are the same as the corresponding components of the first embodiment. Such components will not be described in detail.

FIGS. 9A to 9D illustrate an example of the actuation state of the manufacturing apparatus when the operations of the pre-processing device 30 and the post-processing device 70 are stopped due to an abnormality or the like.

As shown in FIG. 9A, in the manufacturing apparatus of the present example, two workpieces W are retained in the retention space SP1 and two workpieces W may be retained in the vacant space SP2 during normal operation of the devices 30, 40, 50, 60, and 70.

Further, in the present example, when the operations of the pre-processing device 30 and the post-processing device 70 are stopped, the workpiece W is present inside the molding device 50. In this case, the molding device 50 is in a normal operation state. Thus, the molding device 50 continues to perform the molding step on the workpiece W inside even after the operations of the pre-processing device 30 and the post-processing device 70 are stopped. Thus, as shown in FIG. 9B, after the completion of the molding step, the workpiece W in the molding device 50 is moved to and retained at the standby position PA of the molding device 50.

Then, when the predetermined period T elapses from the most recent execution of the molding step, the molding device 50 uses one of the two workpieces W retained in the retention space SP1 and performs the molding step. As shown in FIG. 9C, the quantity of the workpieces W retained in the retention space SP1 is decreased by one and becomes equal to one. The workpiece W after the completion of the molding step is retained at the standby position PA. One workpiece W is retained in the vacant space SP2.

Thereafter, if the predetermined period T elapses again from the most recent execution of the molding step, the molding device 50 uses the one workpiece W remaining in the retention space SP1 and performs the molding step. As shown in FIG. 9D, the quantity of the workpieces W in the retention space SP1 becomes equal to zero, and the quantity of the workpieces W retained in the vacant space SP2 is increased by one and becomes equal to two. In other words, the number of vacant spots becomes equal to zero. The workpiece W after the completion of the molding step is retained at the standby position PA.

In the example shown in FIGS. 9A to 9D, even when the operation of the pre-processing device 30 and/or the post-processing device 70 is stopped, the molding machine 51 continues to operate in an intermittent manner by using the two workpieces W retained in the retention space SP1 and the vacant space SP2 set in the second conveying device 60.

As long as quantity A of the workpieces W that may be retained in the vacant space SP2 is greater than or equal to quantity B of the workpieces W that are retained in advance in the retention space SP1, the quantities A and B of the workpieces W may be changed in any manner. For example, the quantity A of the workpieces W that may be retained in the vacant space SP2 may be set to four, and the quantity B of the workpieces W that are retained in the retention space SP1 in advance may be set to two.

The condition “operation of at least one of the pre-processing device 30 and the post-processing device 70 is stopped” in S17 of the actuation control process (FIG. 6) may be changed to “operation of at least one of the pre-processing device 30 and the post-processing device 70 is stopped when the manufacture of the rotor 10 is ended”.

The method for manufacturing a rotor and the apparatus for manufacturing a rotor in accordance with the above embodiment may also be applied to a manufacturing apparatus including a molding machine that uses a thermosetting resin material.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A method for manufacturing a rotor, the rotor including a rotor core having a magnet housing hole, a magnet accommodated in the magnet housing hole, and a resin material filling the magnet housing hole and fixing the magnet to the rotor core, the method comprising:
a pre-processing step of forming a workpiece in which the magnet is accommodated in the magnet housing hole;
a first conveying step of conveying the workpiece to a molding device, the molding device including a molding machine, by a first conveying device after the pre-processing step;
a molding step of molding the resin material in the magnet housing hole by the molding device after the first conveying step;
a second conveying step of conveying the workpiece from the molding device to a post-processing device by a second conveying device after the molding step; and
a post-processing step of performing a post-processing process on the workpiece by the post-processing device after the second conveying step, wherein:
during normal execution of the steps of manufacturing the rotor, the steps are performed so that a predetermined number of the workpiece is retained in a retention space of the first conveying device, and a vacant space for retaining the predetermined number or more of the workpiece is set in the second conveying device; and
when at least one of the pre-processing step and the post-processing step is stopped, the first conveying step conveys the workpiece retained in the retention space to the molding device, the molding step performs molding of the resin material on the conveyed workpiece by the molding device, and the second conveying step conveys the workpiece after the molding step to the vacant space.

2. The method according to claim 1, wherein the vacant space is set as a space for retaining a number of the workpiece, the number being obtained by adding one to the predetermined number.

3. The method according to claim 1, wherein the vacant space is set as a space for retaining the predetermined number of the workpiece.

4. The method according to claim 1, wherein, during normal execution of the steps, the first conveying step conveys the workpiece retained in the retention space of the first conveying device to the molding device under a condition in which the first conveying device retains a number of the workpiece, the number being obtained by adding one to the predetermined number.

5. The method according to claim 1, wherein the molding step molds the resin material with a thermoplastic resin material.

6. An apparatus for manufacturing a rotor, the rotor including a rotor core having a magnet housing hole, a magnet accommodated in the magnet housing hole, and a resin material filling the magnet housing hole and fixing the magnet to the rotor core, the apparatus comprising:
a pre-processing device configured to form a workpiece in which the magnet is accommodated in the magnet housing hole;
a molding device including a molding machine and configured to mold the resin material in the magnet housing hole in the workpiece with the molding machine;
a post-processing device configured to perform a post-processing process on the workpiece in which the resin material is molded;
a first conveying device configured to convey the workpiece from the pre-processing device to the molding device;
a second conveying device configured to convey the workpiece from the molding device to the post-processing device; and
circuitry that controls actuation of the devices in the manufacturing apparatus, wherein:
during normal operation of the devices, the circuitry is configured to control actuation of the devices so that a predetermined number of the workpiece is retained in the first conveying device, and a vacant space for retaining the predetermined number or more of the workpiece is set in the second conveying device; and
when at least one of the pre-processing device and the post-processing device is stopped, the circuitry is configured to control actuation of the molding device, the first conveying device, and the second conveying device so that the workpiece retained in the first conveying device is conveyed to the molding device, the molding device performs molding of the resin material on the conveyed workpiece, and the workpiece after the molding of the resin material is ejected to the vacant space of the second conveying device.

7. A method for manufacturing a rotor, the rotor including a rotor core having a magnet housing hole, a magnet accommodated in the magnet housing hole, and a resin material filling the magnet housing hole and fixing the magnet to the rotor core, the method comprising:
a pre-processing of forming a workpiece in which the magnet is accommodated in the magnet housing hole;
a first conveying of the workpiece to a molding device, the molding device including a molding machine, by a first conveying device;
molding the resin material in the magnet housing hole by the molding device;
a second conveying of the workpiece from the molding device to a post-processing device by a second conveying device; and
performing a post-processing process on the workpiece by the post-processing device, wherein:
during the manufacturing of the rotor, a predetermined number of the workpiece is retained in a retention space of the first conveying device, and a vacant space for retaining the predetermined number or more of the workpiece is set in the second conveying device; and
when at least one of the pre-processing and the post-processing is stopped, the first conveying conveys the workpiece retained in the retention space to the molding device, the molding performs molding of the resin material on the conveyed workpiece by the molding device, and the second conveying conveys the workpiece after the molding to the vacant space.

8. The method according to claim 7, wherein the vacant space is set as a space for retaining a number of the workpiece, the number being obtained by adding one to the predetermined number.

9. The method according to claim 7, wherein the vacant space is set as a space for retaining the predetermined number of the workpiece.

10. The method according to claim 7, wherein
the first conveying conveys the workpiece retained in the retention space of the first conveying device to the molding device under a condition in which the first conveying device retains a number of the workpiece, the number being obtained by adding one to the predetermined number.

11. The method according to claim 7, wherein the molding molds the resin material with a thermoplastic resin material.
